(19) United States
(12) Patent Application Publication
(10) Pub. No.: US 2017/0260866 A1
(43) Pub. Date: Sep. 14, 2017

(54) DUCTING ARRANGEMENT IN A COMBUSTION SYSTEM OF A GAS TURBINE ENGINE

(71) Applicant: SIEMENS ENERGY, INC., ORLANDO, FL (US)

(72) Inventors: Joseph Meadows, Charlotte, NC (US); Juan Enrique Portillo Bilbao, Oviedo, FL (US); Walter Ray Laster, Oviedo, FL (US); Andrew J. North, Orlando, FL (US)

(21) Appl. No.: 15/066,542

(22) Filed: Mar. 10, 2016

(51) Int. Cl. F01D 9/02; F02C 7/22; F23R 3/28

(52) U.S. Cl. CPC F01D 9/023; F23R 3/286; F02C 7/222; F05D 2230/50; F05D 2250/50; F05D 2220/32

(57) ABSTRACT

A ducting arrangement (30) in a combustion system of a gas turbine engine is provided. The ducting arrangement may be formed by duct segments (32) circumferentially adjoined with one another to form a flow duct structure (e.g., a flow-accelerating structure (34)) and a pre-mixing structure (35). The flow duct structure is fluidly coupled to pass a cross-flow of combustion gases. The pre-mixing structure (35) may include an array of pre-mixing tubes (48) fluidly coupled to receive air and fuel conveyed by a manifold (42) to inject a mixture of air and fuel into the cross-flow of combustion gases that passes through the flow duct structure. The duct segments or the entire ducting arrangement may be formed as a unitized structure, such as a single piece using a rapid manufacturing technology, such as 3D Printing/Additive Manufacturing (AM) technology.

### CROSS-REFERENCE TO RELATED APPLICATIONS

The present application is related to U.S. patent application Ser. No. ______ (Attorney Docket 201604823) titled “Method and Computer-Readable Model for Additively Manufacturing Ducting Arrangement for a Combustion System in a Gas Turbine Engine”, filed concurrently herewith and incorporated by reference in its entirety.

### STATEMENT REGARDING FEDERALLY SPONSORED DEVELOPMENT

Development for this invention was supported in part by Contract No. DE-FE0023968, awarded by the United States Department of Energy. Accordingly, the United States Government may have certain rights in this invention.

### BACKGROUND

1. Field

Disclosed embodiments are generally related to combustion turbine engines, such as gas turbine engines and, more particularly, to a ducting arrangement in a combustion system of the combustion turbine engine.

2. Description of the Related Art

In gas turbine engines, fuel is delivered from a fuel source to a combustion section where the fuel is mixed with air and ignited to generate hot combustion products that define working gases. The working gases are directed to a turbine section where they effect rotation of a turbine rotor. It is known that production of NOx emissions can be reduced by reducing the residence time in the combustor. The residence time in the combustion section may be reduced by providing a portion of the fuel to be ignited downstream from a main combustion zone. This approach is referred to in the art as a distributed combustion system (DCS). See, for example, U.S. Pat. Nos. 8,375,726 and 8,752,386.

It is also known that certain ducting arrangements in a gas turbine engine may be configured to appropriately align the flow of working gases, so that, for example, such flow alignment may be tailored to avoid the need of a first stage of flow-directing vanes in the turbine section of the engine. See for example U.S. Pat. Nos. 7,721,547 and 8,276,389. Each of the above-listed patents is herein incorporated by reference.

### BRIEF DESCRIPTION OF THE DRAWINGS

FIG. 1 is a fragmentary schematic representation of an assembly of combustor transition ducts that may include a respective flow-accelerating structure, such as a flow-accelerating cone, that can benefit from disclosed aspects.

FIG. 2 is an isometric view from an upstream side of a disclosed ducting arrangement.

FIG. 3 is an isometric view from a downstream side of the disclosed ducting arrangement shown in FIG. 2.

FIG. 4 is a side view of a duct segment that may be used as a building block to construct one embodiment of a disclosed ducting arrangement.

FIG. 5 illustrates structural details in connection with a pre-mixing tube that may be used in a disclosed ducting arrangement.

FIG. 6 is an isometric view from an upstream side of another disclosed ducting arrangement.

FIG. 7 is a flow chart listing certain steps that may be used in a disclosed method for manufacturing a ducting arrangement for a combustion system in a gas turbine engine.

FIG. 8 is a flow chart listing further steps that may be used in the disclosed method for manufacturing the ducting arrangement.

FIG. 9 is a flow chart listing certain steps that may be used in the event duct segments are used as building blocks to make the ducting arrangement.

FIG. 10 is a flow sequence in connection with the disclosed method for manufacturing the ducting arrangement.

### DETAILED DESCRIPTION

There are certain advantages that can result from the integration of combustor design approaches, such as may involve a distributed combustion system (DCS) approach, and an advanced ducting approach in the combustor system of a combustion turbine engine, such as a gas turbine engine. For example, with appropriate integration of these design approaches, it is contemplated to achieve a decreased static temperature and a reduced combustion residence time, each of which is conducive to reduce NOx emissions to be within acceptable levels at turbine inlet temperatures of approximately 1700° C. (3200° F.) and above.

The present inventors have recognized that traditional manufacturing techniques may not be conducive to a cost-effective manufacturing of combustor components that may be involved to implement the foregoing approaches. For example, traditional manufacturing techniques tend to fall somewhat short from consistently limiting manufacturing variability; and may also fall short from cost-effectively and reliably producing the relatively complex geometries and miniaturized features and/or conduits that may be involved in such combustor components.

In view of such a recognition, in one non-limiting embodiment, the present inventors propose use of three-dimensional (3D) Printing/Additive Manufacturing (AM) technologies, such as laser sintering, selective laser melting (SLM), direct metal laser sintering (DMLS), electron beam sintering (EBS), electron beam melting (EBM), etc., that may be conducive to cost-effectively making an innovative ducting arrangement that may involve complex geometries and miniaturized features and/or conduits in a combustion system of a gas turbine engine. For readers desirous of general background information in connection with 3D Printing/Additive Manufacturing (AM) technologies, see, for example, textbook titled “Additive Manufacturing Technologies, 3D Printing, Rapid Prototyping, and Direct Digital Manufacturing”, by Gibson I., Stucker B., and Rosen D., 2010, published by Springer, which textbook is incorporated herein by reference.

In one non-limiting embodiment, it is contemplated the feasibility of cost-effectively and reliably making a plurality of duct segments that can be circumferentially adjoined with one another to form a flow-accelerating structure fluidly coupled to pass a cross-flow of combustion gases, such as from a combustor outlet. The adjoined duct segments can additionally form a pre-mixing array conducive to an array of mixture injection locations arranged at the flow-accelerating structure to inject a mixture of air and fuel into the cross-flow of combustion gases that passes through the flow-accelerating structure. That is, the air and fuel are effectively premixed prior to injection into the cross-flow of combustion gases.

In one non-limiting embodiment, the duct segments may comprise unitized duct segments. The term “unitized” in the context of this application, unless otherwise stated, refers to a structure which is formed as a single piece (e.g., monolithic construction) using a rapid manufacturing technology, such as without limitation, 3D Printing/Additive Manufacturing (AM) technology, where the unitized structure, singly or in combination with other unitized structures, can form a component of the combustion turbine engine, such as for example segments of a duct arrangement, or the entire duct arrangement.

In the following detailed description, various specific details are set forth in order to provide a thorough understanding of such embodiments. However, those skilled in the art will understand that embodiments of the present invention may be practiced without these specific details, that the present invention is not limited to the depicted embodiments, and that the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may. It is noted that disclosed embodiments need not be construed as mutually exclusive embodiments, since aspects of such disclosed embodiments may be appropriately combined by one skilled in the art depending on the needs of a given application.

The terms “comprising”, “including”, “having”, and the like, as used in the present application, are intended to be synonymous unless otherwise indicated. Lastly, as used herein, the phrases “configured to” or “arranged to” embrace the concept that the feature preceding the phrases “configured to” or “arranged to” is intentionally and specifically designed or made to act or function in a specific way and should not be construed to mean that the feature just has a capability or suitability to act or function in the specified way, unless so indicated.

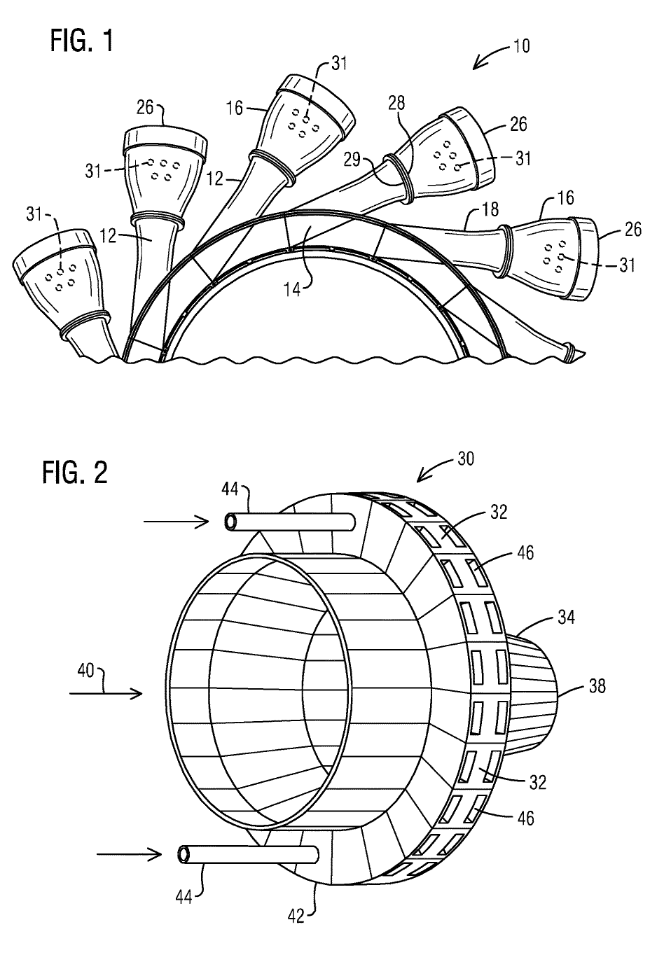

FIG. 1 is a fragmentary schematic representation of an assembly of transition ducts 10 in a combustor system of a combustion turbine engine, such as a gas turbine engine. In assembly 10, a plurality of flow paths 12 blends smoothly into a single, annular chamber 14. In one non-limiting embodiment, each flow path 12 may be configured to deliver combustion gases formed in a respective combustor to a turbine section of the engine without a need of a first stage of flow-directing vanes in the turbine section of the engine.

In one non-limiting embodiment, each flow path 12 includes a cone 16 and an integrated exit piece (IEP) 18. In one non-limiting embodiment, each cone 16 has a cone inlet 26 having a circular cross section and configured to receive the combustion gases from a combustor outlet (not shown). The cross-sectional profile of cone 16 narrows toward a cone outlet 28 that is associated with an IEP inlet 29 in fluid communication with each other.

Based on the narrowing cross-sectional profile of cone 16, as the flow travels from cone inlet 26 to cone outlet 28, the flow of combustion gases is accelerated to a relatively high subsonic Mach (Ma) number, such as without limitation may comprise a range from approximately 0.3 M to approximately a 0.8 M, and thus cone 16 may be generally conceptualized as a non-limiting embodiment of a flow-accelerating structure. Accordingly, the combustion gases may flow through cone 16 with an increasing flow speed, and as a result, this flow of combustion gases can experience a decreasing static temperature in cone 16, and a reduced combustion residence time, each of which is conducive to reduce NOx emissions at the high firing temperatures of a combustion turbine engine.

In accordance with disclosed aspects, by injecting pre-mixed reactants, (e.g., fuel and air) at locations of the cone having a relatively lower static temperature, such as a location between cone inlet 26 and cone outlet 28, it is feasible to effectively bring the reaction temperature below the thermal NOx formation threshold even though, in certain non-limiting embodiments, the firing temperature may be approximately 1700° C. and higher. That is, the mixture injector locations may be disposed where the static temperature is lower compared to the static temperature at cone inlet 26. For the sake of simplicity of illustration, FIG. 1 illustrates a conceptual schematic representation of mixture injection locations denoted by small dashed circles 31, in connection with each of the cones illustrated in FIG. 1. Structural and/or operational relationships for integrating such mixture injector locations with the flow-accelerating structure are elaborated in greater detail below.

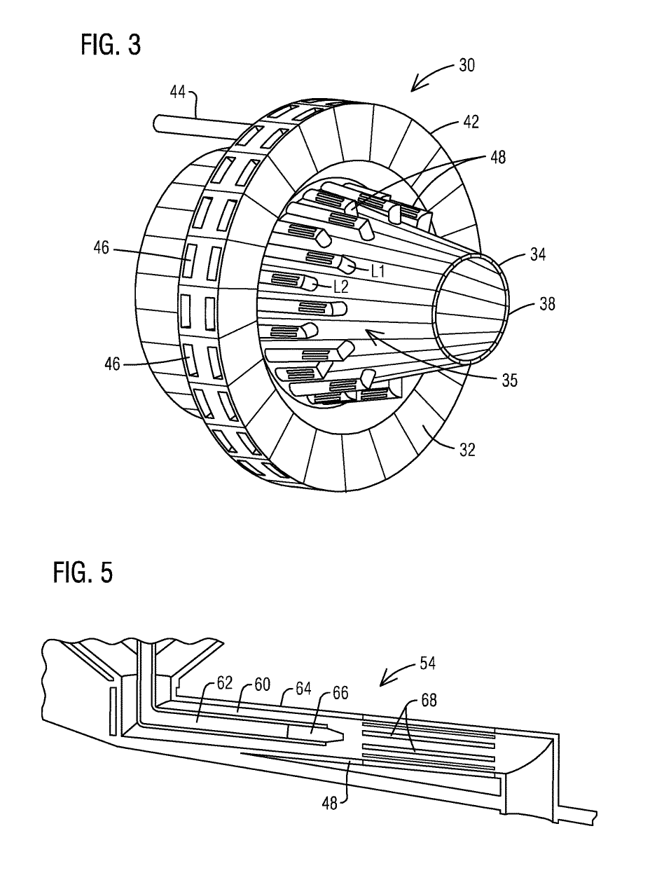

FIGS. 2 and 3 are respective isometric views of a disclosed ducting arrangement 30. More specifically, FIG. 2 is a view from an upstream side of ducting arrangement 30 while FIG. 3 is a view from a downstream side of ducting arrangement 30. In one non-limiting embodiment, ducting arrangement 30 may comprise a plurality of arcuate duct segments 32 circumferentially adjoined with one another to form a flow duct structure 34 and a pre-mixing structure 35 (FIG. 3). In one non-limiting embodiment, each duct segment 32 may be a unitized structure. That is, a structure which is formed as a single piece using a rapid manufacturing technology, such as without limitation, 3D Printing/Additive Manufacturing (AM) technology.

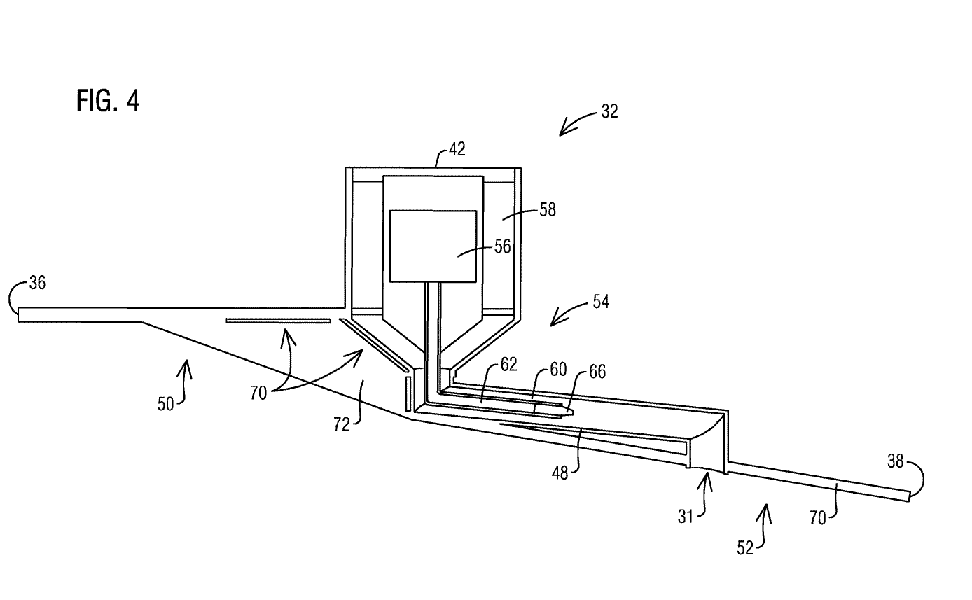

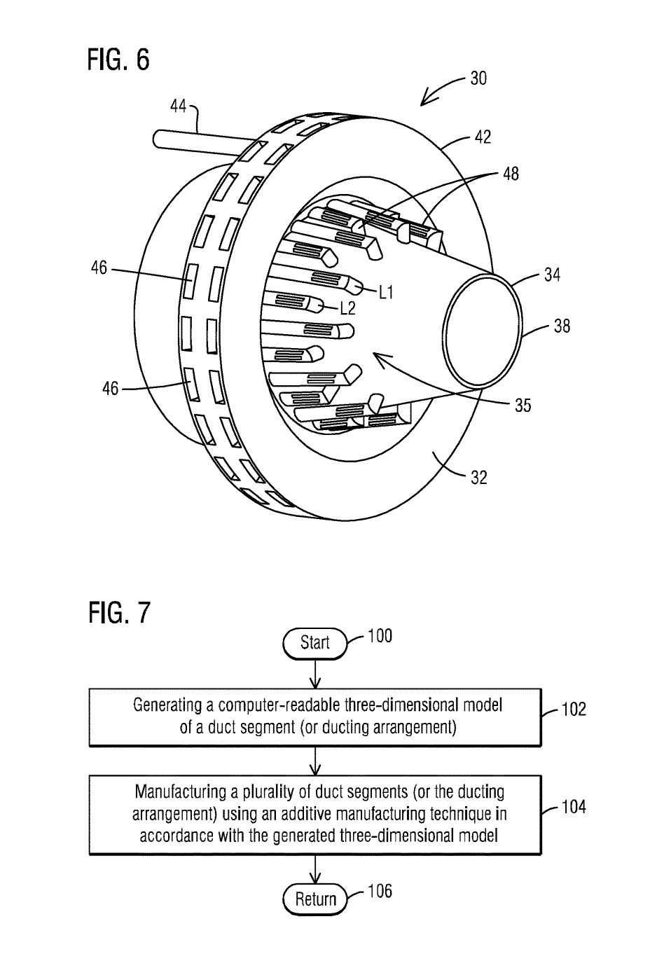

In this embodiment, duct segments 32 may be conceptualized as building blocks that may be adjoined with one another to form ducting arrangement 30. In one non-limiting embodiment, as may be appreciated in FIG. 4, duct segments 32 may be circumferentially adjoined with one another by way of brazing joints 70 disposed at respective mutually opposed lateral surfaces 72 of each adjoining duct segment 32. Alternatively, as shown in FIG. 6, ducting arrangement 30 may be a unitized structure that singularly forms ducting arrangement 30.

Flow duct structure 34 has an inlet 36 and an outlet 38. The inlet 36 of flow duct structure 34 is fluidly coupled to pass a cross-flow of combustion gases (schematically represented by arrow 40) from a combustor outlet (not shown). In one non-limiting embodiment, pre-mixing structure 35 comprises a manifold 42 that respectively receives fuel by way of one or more fuel inlets 44, and further receives air by way of air inlets 46. Manifold 42 defines respective fuel and air plenums formed by a combination of respective manifold segments 56, 58 (FIG. 4), and thus manifold 42 in effect comprises a respective fuel manifold and a respective air manifold.

Pre-mixing structure 35 further comprises an array of pre-mixing tubes 48 fluidly coupled to receive air and fuel conveyed by manifold 42. Pre-mixing tubes 48 define an array of mixture injection locations 31 (as conceptually shown in FIG. 1; and further illustrated in FIG. 4, which shows one mixture injection location) arranged at flow duct structure 34 to inject a mixture of air and fuel into the cross-flow of combustion gases that passes through flow duct structure 34.

In one non-limiting embodiment, flow duct structure 34 comprises a flow-accelerating cone and the array of mixture injection locations 31 is circumferentially arranged in a wall of the cone. In one non-limiting embodiment, as may be appreciated in FIG. 3, at least some of the mixture injection locations 31 may be disposed at different axial locations (schematically labeled L1 and L2) in the wall of the cone. Mixture injection locations be disposed at different axial locations is conducive to an improved distribution of heat release and thus effective to improved combustion dynamics. It will be appreciated that the array of mixture injection locations 31 is not limited to any specific location, or to any specific number of different axial locations in the wall of the cone. Thus, the mixture injection locations shown in the drawings should not be construed in a limiting sense. Moreover, depending on the needs of a given application, the array of mixture injection locations 31 need not be located in the flow-accelerating structure since other combustor components (e.g., a straight flow duct, combustor basket, etc.) could benefit from disclosed pre-mixing structure 35.

FIG. 4 is a side view of a disclosed duct segment 32 that may be used to construct the ducting arrangement. In one non-limiting embodiment, each duct segment 32 may comprise an upstream duct segment 50 extending longitudinally from inlet 36 of the ducting arrangement. Each duct segment 32 may further comprise a downstream duct segment 52 extending longitudinally from upstream duct segment 52 toward outlet 38 of the ducting arrangement.

In one non-limiting embodiment, upstream duct segment 50 and downstream duct segment 52 may define a convergent profile as duct segments 50, 52 respectively extend from inlet 36 to outlet 38 of the ducting arrangement. Each duct segment 32 may be additionally formed with a pre-mixing duct segment 54 to pre-mix fuel and air. In one non-limiting embodiment, pre-mixing duct segment 54 is disposed radially outwardly with respect to upstream duct segment 50 and downstream duct segment 52. In one non-limiting embodiment, upstream duct segment 50, downstream duct segment 52 and pre-mixing duct segment 54 comprise circumferentially arcuate duct segments and form a unitized structure.

In one non-limiting embodiment, pre-mixing duct segment 54 includes respective manifold segments 56, 58 and respective conduits 60, 62 constructed within pre-mixing duct segment 54 to respectively convey fuel and air to a pre-mixing tube 48 arranged in pre-mixing duct segment 54 to pre-mix the received fuel and air. When a plurality of duct segments 32 is circumferentially adjoined with one another, the respective manifold segments 56, 58 in combination form respective fuel and air plenums in manifold 42 (FIGS. 2 and 3). Pre-mixing tube 48 contains a respective fuel injector 66 to inject fuel conveyed by the manifold. Fuel injector 66 is not limited to any particular modality and, without limitation, may comprise micro-nozzles with or without vortex-generating features. In one non-limiting embodiment, pre-mixing tube 48 and fuel injector 66 may be a unitized structure. Without limitation, practical embodiments may comprise fluid flow conduits having a minimum diameter in a range from about 0.75 mm to about 1 mm.

As may be appreciated in FIG. 5, in one non-limiting embodiment pre-mixing tube 48 may include a number of slots 68 (further air inlets, independent from air inlets 46) disposed downstream from a fuel injection location of fuel injector 66. Slots 68 may be configured arranged to receive a further amount of air independent from air conveyed by manifold 42. It will be appreciated that the configuration of air inlets 46 and further air inlets 68 is not limited to any particular geometrical configuration.

In operation, disclosed embodiments, such as may comprise a unitized structure integrating a flow-accelerating structure and a pre-mixing structure, can allow for a relatively large number of miniaturized air and fuel flow paths effective to form a mixture of air and fuel that can be injected into the cross-flow from an upstream combustion stage, where such a mixture is pre-mixed in the pre-mixing structure prior to injection into the cross-flow. Additionally, the level of pre-mixing can be flexibly tailored based on the needs of a given application. Without limitation, the level of pre-mixing could be tailored depending on the different axial lengths of the pre-mixing tubes. Also by constructing further air inlets, (e.g., slots 68) downstream of the fuel injection of the fuel injector, the level of localized pre-mixing can be enhanced. For example, the further amount of air received through slots 68 may be effective to increase a momentum flux ratio of this further amount of air to the fuel/air mixture in the pre-mixing tube.

In operation, disclosed embodiments are expected to be conducive to a combustion system capable of realizing approximately a 65% combined cycle efficiency or greater in a gas turbine engine. Disclosed embodiments are also expected to realize a combustion system capable of maintaining stable operation at turbine inlet temperatures of approximately 1700° C. and higher while maintaining a relatively low level of NOx emissions, and acceptable temperatures in components of the engine without an increase in cooling air consumption.

FIG. 7 is a flow chart listing certain steps that may be used in a disclosed method for manufacturing a ducting arrangement for a combustion system in a gas turbine engine. As shown in FIG. 7, after a start step 100, step 102 allows generating a computer-readable three-dimensional (3D) model, such as a computer aided design (CAD) model, of a duct segment. This approach would be used in the event duct segments are used as building blocks to make the ducting arrangement. Alternatively, in lieu of generating a computer-readable three-dimensional (3D) model of a duct segment, one can generate a computer-readable three-dimensional (3D) model of the ducting arrangement, in the event a ducting arrangement is made as a singular piece. In either case, the model defines a digital representation of a duct segment (or the ducting arrangement), as described above in the context of the preceding figures.

Prior to return step 106, step 104 allows manufacturing a plurality of duct segments (or the ducting arrangement) using an additive manufacturing technique in accordance with the generated three-dimensional model. Non-limiting examples of additive manufacturing techniques may include laser sintering, selective laser melting (SLM), direct metal laser sintering (DMLS), electron beam sintering (EBS), electron beam melting (EBM), etc. It will be appreciated that once a model has been generated, or otherwise available (e.g., loaded into a 3D digital printer, or loaded into a processor that controls the additive manufacturing technique), then manufacturing step 104 need not be preceded by a generating step 102.

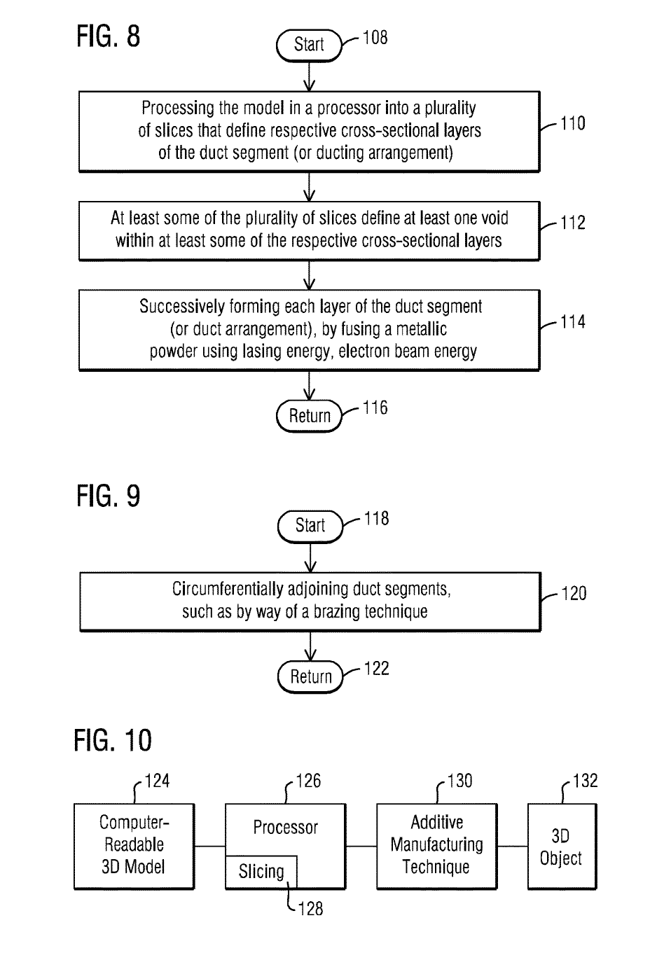

FIG. 8 is a flow chart listing further steps that may be used in the disclosed method for manufacturing the ducting arrangement. In one non-limiting embodiment, manufacturing step 104 (FIG. 7) may include the following: after a start step 108, step 110 allows processing the model in a processor into a plurality of slices that define respective cross-sectional layers of the duct segment (or the ducting arrangement). As described in step 112, at least some of the plurality of slices define one or more voids (e.g., respective voids that may be used to form hollow portions of pre-mixing tube 48, manifold segments 56, 58, conduits 60, 62, slots 68, air inlets 46, etc.) within at least some of the respective cross-sectional layers. Prior to return step 116, step 114 allows successively forming each layer of the duct segment (or the ducting arrangement) by fusing a metallic powder using a suitable source of energy, such as without limitation, lasing energy or electron beam energy.

FIG. 9 is a flow chart listing certain steps that may be used in the event duct segments are used as building blocks to make the ducting arrangement. Subsequent to start step 118, step 120 allows circumferentially adjoining the plurality of duct segments with one another to form flow-accelerating structure 34 and pre-mixing structure 35 (FIG. 3). This may be accomplished by joining respective mutually opposed lateral surfaces 72 (FIG. 4) of each adjoining duct segment 32 by way of a non-additive manufacturing metal-joining technique, such as a brazing technique, etc.

FIG. 10 is a flow sequence in connection with a disclosed method for manufacturing a 3D object 132, such as a duct segment or the ducting arrangement. A computer-readable three-dimensional (3D) model 124, such as a computer aided design (CAD) model, of the 3D object may be processed in a processor 126, where a slicing module 128 converts model 124 into a plurality of slice files (e.g., 2D data files) that defines respective cross-sectional layers of the 3D object. Processor 126 may be configured to control an additive manufacturing technique 130 used to make 3D object 132.

In one non-limiting embodiment, a duct segment is manufactured using an additive manufacturing technique in accordance with a computer-readable three-dimensional model of a duct segment. The model of the duct segment is processable in a processor configured to control the additive manufacturing technique. The duct segment may be characterized by an upstream duct segment arranged to extend longitudinally from an inlet of the ducting arrangement; a downstream duct segment arranged to extend longitudinally from the upstream duct segment toward an outlet of the ducting arrangement, wherein the upstream duct segment and the downstream duct segment define a convergent profile as said duct segments respectively extend from the inlet to the outlet of the ducting arrangement; and a pre-mixing duct segment to pre-mix fuel and air, the pre-mixing duct segment disposed radially outwardly with respect to the upstream and the downstream duct segments.

In one non-limiting embodiment, a ducting arrangement is manufactured using an additive manufacturing technique in accordance with a computer-readable three-dimensional model of a ducting arrangement. The model of the ducting arrangement is processable in a processor configured to control the additive manufacturing technique. The ducting arrangement may be characterized by a flow-accelerating structure and a pre-mixing structure, the flow-accelerating structure having an inlet and an outlet, the inlet of the flow-accelerating structure to be fluidly coupleable to pass a cross-flow of combustion gases from a combustor outlet; the pre-mixing structure comprising: a manifold comprising respective conduits constructed within the pre-mixing structure to respectively convey fuel and air; and an array of pre-mixing tubes to be fluidly coupleable to receive air and fuel conveyed by the manifold, wherein the pre-mixing tubes define an array of mixture injection locations arranged at the flow-accelerating structure to inject a mixture of air and fuel into the cross-flow of combustion gases that passes through the flow-accelerating structure.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A ducting arrangement in a combustion system, the ducting arrangement comprising:
a plurality of duct segments circumferentially adjoined with one another to form a flow duct structure and a pre-mixing structure,
the flow duct structure having an inlet and an outlet, the inlet of the flow duct structure fluidly coupled to pass a cross-flow of combustion gases from a combustor outlet;
the pre-mixing structure comprising:
a manifold comprising respective conduits constructed within the pre-mixing structure to respectively convey fuel and air; and
an array of pre-mixing tubes fluidly coupled to receive air and fuel conveyed by the manifold, wherein the pre-mixing tubes define an array of mixture injection locations arranged at the flow duct structure to inject a mixture of air and fuel into the cross-flow of combustion gases that passes through the flow duct structure.

2. The ducting arrangement of claim 1, wherein each duct segment comprises a unitized structure.

3. The ducting arrangement of claim 1, wherein the flow duct structure comprises a flow-accelerating cone and the array of mixture injection locations is circumferentially arranged in a wall of the cone.

4. The ducting arrangement of claim 3, wherein at least some of the mixture injection locations are disposed at different axial locations in the wall of the cone.

5. The ducting arrangement of claim 4, wherein the array of mixture injection locations is flush with a radially-inner surface of the wall of the cone.

6. The ducting arrangement of claim 1, wherein each pre-mixing tube contains a respective fuel injector to inject fuel conveyed by the manifold.

7. The ducting arrangement of claim 6, wherein each pre-mixing tube and the respective fuel injector contained therein comprises a unitized structure.

8. The ducting arrangement of claim 6, wherein each pre-mixing tube comprises a number of slots disposed downstream from a fuel injection location of the respective fuel injector, the slots arranged to receive a further amount of air independent from air conveyed by the manifold.

9. The ducting arrangement of claim 1, wherein the plurality of duct segments comprises arcuate duct segments.

10. The ducting arrangement of claim 1, wherein the plurality of duct segments is circumferentially adjoined with one another by way of brazing joints disposed at respective mutually opposed lateral surfaces of each adjoining duct segment.

11. A gas turbine engine comprising the ducting arrangement of claim 1.

12. A ducting arrangement in a combustion system, the ducting arrangement comprising:
a unitized structure configured to form a flow-accelerating structure and a pre-mixing structure, the flow-accelerating structure having an inlet and an outlet, the inlet of the flow-accelerating structure fluidly coupled to pass a cross-flow of combustion gases from a combustor outlet;
the pre-mixing structure comprising:
a manifold comprising respective conduits constructed within the pre-mixing structure to respectively convey fuel and air; and
an array of pre-mixing tubes fluidly coupled to receive air and fuel conveyed by the manifold, wherein the pre-mixing tubes define an array of mixture injection locations arranged at the flow-accelerating structure to inject a mixture of air and fuel into the cross-flow of combustion gases that passes through the flow-accelerating structure.

13. The ducting arrangement of claim 12, wherein the flow-accelerating structure comprises a flow-accelerating cone and the array of mixture injection locations is circumferentially arranged in a wall of the cone, and further wherein at least some of the mixture injection locations are disposed at different axial locations in the wall of the cone.

14. The ducting arrangement of claim 12, wherein each pre-mixing tube contains a respective fuel injector to inject fuel conveyed by the manifold, wherein each pre-mixing tube comprises a number of slots disposed downstream from a fuel injection location of the respective fuel injector, the slots arranged to receive a further amount of air independent from air conveyed by the manifold.

15. A duct segment in a ducting arrangement of a combustion system, the duct segment comprising:
an upstream duct segment extending longitudinally from an inlet of the ducting arrangement;
a downstream duct segment extending longitudinally from the upstream duct segment toward an outlet of the ducting arrangement,
wherein the upstream duct segment and the downstream duct segment define a convergent profile as said duct segments respectively extend from the inlet to the outlet of the ducting arrangement, and
a pre-mixing duct segment to pre-mix fuel and air, the pre-mixing duct segment radially outwardly with respect to the upstream and the downstream duct segments,
wherein the upstream duct segment, the downstream duct segment and the pre-mixing duct segment form a unitized structure.

16. The duct segment of claim 15, wherein the upstream duct segment, the downstream duct segment and the pre-mixing duct segment comprise circumferentially arcuate duct segments.

17. The duct segment of claim 15, wherein the pre-mixing duct segment comprises respective manifold segments and respective conduits constructed within the pre-mixing duct segment to respectively convey fuel and air to a pre-mixing tube arranged in the pre-mixing duct segment to pre-mix the received fuel and air.

18. The duct segment of claim 17, wherein the pre-mixing tube comprises a fuel injector to inject the received fuel.

19. The duct segment of claim 18, wherein the pre-mixing tube comprises a number of slots disposed downstream from a fuel injection location of the fuel injector, the slots arranged to receive a further amount of air independent from air conveyed by the manifold.

20. The ducting arrangement comprising a plurality of duct segments as recited in claim 15, wherein the plurality of duct segments is circumferentially adjoined with one another to form a flow-accelerating structure and a pre-mixing structure, the flow-accelerating structure fluidly coupled to pass a cross-flow of combustion gases from a combustor outlet, wherein pre-mixing structure comprises an array of mixture injection locations arranged at the flow-accelerating structure to inject a mixture of air and fuel to be mixed with the cross-flow of combustion gases that passes through the flow-accelerating structure, wherein the plurality of duct segments is circumferentially adjoined with one another by way of brazing joints disposed at respective mutually opposed lateral surfaces of each adjoining duct segment.
